(19) United States
(12) Patent Application Publication
(10) Pub. No.: US 2020/0152350 A1
(43) Pub. Date: May 14, 2020

(54) COMPOSITION FOR SEALING COVERED WIRE

(71) Applicant: TOAGOSEI CO., LTD., Minato-ku (Tokyo) (JP)

(72) Inventors: Hiroyuki YAMAGA, Nagoya-shi (Aichi) (JP); Masashi YAMADA, Nagoya-shi (Aichi) (JP)

(73) Assignee: TOAGOSEI CO., LTD., Minato-ku (Tokyo) (JP)

(21) Appl. No.: 16/615,444

(22) PCT Filed: May 23, 2018
(86) PCT No.: PCT/JP2018/019871

§ 371 Date: Nov. 21, 2019

(30) Foreign Application Priority Data
May 25, 2017 (JP) 2017-103872

(51) Int. Cl. H01B 3/44; C09K 3/10; C08F 20/50; H01B 3/30

(52) U.S. Cl. CPC H01B 3/447; H01B 3/307; C08F 20/50; C09K 3/10

(57) ABSTRACT

Provided is a composition for sealing a covered wire, the composition containing 2-cyanoacrylate including 10% by mass or more of an alkyl-2-cyanoacrylate that has, in a main chain, an alkyl group having 4 or more carbon atoms, and the composition having both water resistance and thermal shock resistance under high temperature and high humidity conditions and also having excellent heat resistance.

### TECHNICAL FIELD

The present invention relates to a composition for sealing a covered wire, the composition containing 2-cyanoacrylate as a main component.

### BACKGROUND ART

The present invention relates to a composition for sealing a covered wire with excellent sealability of a covered wire even under conditions of high temperature, high humidity, and the like, the composition being widely utilized as a sealant for a covered wire for wiring of a variety of electric systems in automobiles, home appliances, OA equipment, and the like. Herein, an acryloyloxy group and a methacryloyloxy group are generically referred to as a (meth)acryloyloxy group, and an acrylate and a methacrylate are generically referred to as a (meth)acrylate.

In automobiles, home appliances, OA equipment, and the like, a variety of electric systems are wired with wires, and conventionally, a harness portion has only been swaged; however, in this method, gas or moisture may be incorporated into a gap between a conductor and a covering, and the conductor itself may break due to corrosion, precision parts connected to the wire may be degraded, or the above equipment may malfunction.

Therefore, for avoiding such troubles, a method of applying a treatment with a composition for sealing a covered wire to a boundary portion between a covered portion and an exposed portion of a covered wire to fill and adhere the gap, thereby increasing airtightness, has been adopted. In this case, from the viewpoint of workability, a composition for sealing a covered wire is desired to be rapidly cured after percolating between a conductor and a covering.

As a composition for sealing a covered wire that satisfies such a performance, Patent Document 1 discloses a low-viscosity and rapidly curable cyanoacrylate-based composition mainly composed of 2-cyanoacrylate.

However, cured products of conventional cyanoacrylate-based compositions are poor in flexibility. Therefore, in the case in which covered wires sealed using the compositions are bent forcibly, conductors may be disconnected or cured products of the compositions may be broken, resulting in trouble with wiring or loss of sealability of the covered wires.

In order to solve these problems, Patent Document 2 proposes a composition for sealing a covered wire, the composition consisting of: an alkyl-2-cyanoacrylate; a 2-cyanoacrylate having an ether bond in an ester residue; and a (meth) acrylate having two or more (meth)acryloyloxy groups.

In this document, ethyl-2-cyanoacrylate and isobutyl-2-cyanoacrylate are used as the alkyl-2-cyanoacrylate, and ethoxyethyl-2-cyanoacrylate is used as the 2-cyanoacrylate having an ether bond in an ester residue. It is disclosed that a composition consisting of, with respect to a total amount of the composition, 10 to 40% by mass of an alkyl-2-cyanoacrylate, 30 to 80% by mass of an alkoxyalkyl-2-cyanoacrylate, and 1 to 50% by mass of a (meth)acrylate having two or more (meth)acryloyloxy groups is excellent in flexibility and water resistance.

### PRIOR ART DOCUMENTS

### Patent Documents

Patent Document 1: Japanese Patent Application Laid-Open (JP-A) No. S49-33186

Patent Document 2: JP-A No. H09-118839

### SUMMARY OF INVENTION

### Technical Problem

However, as required performance of water resistance or thermal shock resistance under high temperature and high humidity conditions increases, a composition containing a large amount of an alkoxyalkyl-2-cyanoacrylate as described in Patent Document 2 may not be able to satisfy water resistance under high temperature and high humidity conditions. On the other hand, in the case in which an addition amount of an alkoxyalkyl-2-cyanoacrylate is reduced, there may be a problem with thermal shock resistance under high temperature and high humidity conditions. Further, improvement in performance is also required for heat resistance.

The problem to be solved by the present invention is to provide a composition for sealing a covered wire, in which the composition has both water resistance and thermal shock resistance under high temperature and high humidity conditions and also has excellent heat resistance.

### Solution to Problem

Means for solving the above problems includes the following aspects.

<1> A composition for sealing a covered wire, the composition containing 2-cyanoacrylate including 10% by mass or more of an alkyl-2-cyanoacrylate that has, in a main chain, an alkyl group having 4 or more carbon atoms.
<2> The composition for sealing a covered wire according to <1>, in which the alkyl-2-cyanoacrylate that has, in a main chain, an alkyl group having 4 or more carbon atoms is at least one selected from the group consisting of 2-octyl-2-cyanoacrylate, 2-ethylhexyl-2-cyanoacrylate, n-octyl-2-cyanoacrylate, n-hexyl-2-cyanoacrylate, and n-butyl-2-cyanoacrylate.
<3> The composition for sealing a covered wire according to <1> or <2>, the composition further containing at least one of an alkyl-2-cyanoacrylate that has, in a main chain, an alkyl group having 1 to 3 carbon atoms or a 2-cyanoacrylate that has an ether bond in an ester residue.
<4> The composition for sealing a covered wire according to <3>, in which a content ratio of the alkyl-2-cyanoacrylate is 10% by mass or more but 90% by mass or less with respect to a total amount of 2-cyanoacrylate.
<5> The composition for sealing a covered wire according to <3> or <4>, in which a content ratio of the 2-cyanoacrylate that has an ether bond in an ester residue is 0% by mass or more but 40% by mass or less with respect to a total amount of 2-cyanoacrylate.
<6> The composition for sealing a covered wire according to any one of <1> to <5>, the composition further containing a (meth)acrylate that has two or more (meth)acryloyloxy groups.
<7> The composition for sealing a covered wire according to <6>, in which a content ratio of the (meth)acrylate that has two or more (meth)acryloyloxy groups is 50% by mass or less with respect to a total amount of the composition.
<8> The composition for sealing a covered wire according to <6> or <7>, the composition further containing a polymerization initiator.
<9> A covered wire including a cured product of the composition for sealing a covered wire according to any one of <1> to <8>.

### Advantageous Effect of Invention

According to the present invention, a composition for sealing a covered wire, in which the composition has both water resistance and thermal shock resistance under high temperature and high humidity conditions and also has excellent heat resistance, can be provided.

### DESCRIPTION OF EMBODIMENTS

The description of components described below may be made based on a representative embodiment of the present invention, but the present invention is not limited to such an embodiment.

Hereinafter, the present invention will be more specifically described.

The composition for sealing a covered wire of the present invention (hereinafter, sometimes simply referred to as “composition of the present invention”) contains 2-cyanoacrylate including 10% by mass or more of an alkyl-2-cyanoacrylate that has, in a main chain, an alkyl group having 4 or more carbon atoms.

<Alkyl-2-Cyanoacrylate that has, in a Main Chain, an Alkyl Group Having 4 or More Carbon Atoms>

A variety of alkyl-2-cyanoacrylates, each of which has, in a main chain, an alkyl group having 4 or more carbon atoms, which is an essential component of the composition of the present invention, can be used. An upper limit of the carbon number of the main chain is not particularly limited, and may be, for example, 12 or less. Specific examples thereof include n-hexyl-2-cyanoacrylate, n-heptyl-2-cyanoacrylate, 1-methylpentyl-2-cyanoacrylate, n-octyl-2-cyanoacrylate, 2-octyl-2-cyanoacrylate, 2-ethylhexyl-2-cyanoacrylate, n-nonyl-2-cyanoacrylate, isononyl-2-cyanoacrylate, n-decyl-2-cyanoacrylate, isodecyl-2-cyanoacrylate, n-undecyl-2-cyanoacrylate, and n-dodecyl-2-cyanoacrylate. These may be used in combination of two or more.

Among these, it is preferable to use at least one selected from the group consisting of 2-octyl-2-cyanoacrylate, 2-ethylhexyl-2-cyanoacrylate, n-octyl-2-cyanoacrylate, n-hexyl-2-cyanoacrylate, and n-butyl-2-cyanoacrylate, since excellent water resistance and thermal shock resistance under high temperature and high humidity conditions and excellent heat resistance can be obtained. More preferred is 2-octyl-2-cyanoacrylate.

A content of the alkyl-2-cyanoacrylate that has, in a main chain, an alkyl group having 4 or more carbon atoms is 10% by mass or more, preferably from 25% by mass to 100% by mass, and more preferably from 40% by mass to 100% by mass, with respect to a total amount of 2-cyanoacrylate in the composition. When the content is 10% by mass or more, it is possible to impart sufficient water resistance and thermal shock resistance under high temperature and high humidity conditions.

<Alkyl-2-Cyanoacrylate that has, in a Main Chain, an Alkyl Group Having 1 to 3 Carbon Atoms>

The composition of the present invention may contain an alkyl-2-cyanoacrylate that has, in a main chain, an alkyl group having 1 to 3 carbon atoms, for the purpose of improving heat resistance. A variety of alkyl-2-cyanoacrylates, each of which has, in a main chain, an alkyl group having 1 to 3 carbon atoms, may be contained, and specific examples thereof include methyl-2-cyanoacrylate, ethyl-2-cyanoacrylate, n-propyl-2-cyanoacrylate, isopropyl-2-cyanoacrylate, and isobutyl-2-cyanoacrylate. These may be used in combination of two or more.

Among these, isopropyl-2-cyanoacrylate and isobutyl-2-cyanoacrylate are preferably used from the viewpoint of easily improving thermal shock resistance.

From the viewpoint of thermal shock resistance, a content ratio of the alkyl-2-cyanoacrylate that has, in a main chain, an alkyl group having 1 to 3 carbon atoms is preferably 10% by mass or more but 90% by mass or less with respect to a total amount of 2-cyanoacrylate in the composition, and more preferably, in the case of isopropyl-2-cyanoacrylate or isobutyl-2-cyanoacrylate, the content ratio is 10% by mass or more but 60% by mass or less with respect to a total amount of 2-cyanoacrylate in the composition, and in the case of methyl-2-cyanoacrylate, ethyl-2-cyanoacrylate, or n-propyl-2-cyanoacrylate, the content ratio is 10% by mass or more but 30% by mass or less with respect to a Total Amount of 2-Cyanoacrylate in the Composition.

<2-Cyanoacrylate that has an ether bond in an ester residue>

In the composition of the present invention, a 2-cyanoacrylate that has an ether bond in an ester residue may be contained for the purpose of imparting flexibility related to thermal shock resistance, and examples thereof include an alkoxyalkyl-2-cyanoacrylate and a 2-cyanoacrylate of a cyclic alkyl ether.

Specific examples of the alkoxyalkyl-2-cyanoacrylate include methoxyethyl-2-cyanoacrylate, ethoxyethyl-2-cyanoacrylate, propoxyethyl-2-cyanoacrylate, isopropoxyethyl-2-cyanoacrylate, butoxyethyl-2-cyanoacrylate, hexyloxyethyl-2-cyanoacrylate, 2-ethylhexyloxyethyl-2-cyanoacrylate, butoxyethoxyethyl-2-cyanoacrylate, hexyloxyethoxyethyl-2-cyanoacrylate, 2-ethylhexyloxyethoxyethyl-2-cyanoacrylate, methoxypropyl-2-cyanoacrylate, methoxypropoxypropyl-2-cyanoacrylate, methoxypropoxypropoxypropyl-2-cyanoacrylate, ethoxypropyl-2-cyanoacrylate, and ethoxypropoxypropyl-2-cyanoacrylate. Specific examples of the 2-cyanoacrylate of a cyclic alkyl ether include tetrahydrofurfuryl-2-cyanoacrylate. These may be used in combination of two or more.

Among these, a lower alkoxyethyl-2-cyanoacrylate such as methoxyethyl-2-cyanoacrylate, ethoxyethyl-2-cyanoacrylate, or butoxyethyl-2-cyanoacrylate is preferably used from the viewpoint of availability and excellent stability.

From the viewpoint of water resistance and thermal shock resistance, a content ratio of the 2-cyanoacrylate that has an ether bond in an ester residue is preferably 40% by mass or less, and more preferably 30% by mass or less, with respect to a total amount of 2-cyanoacrylate in the composition. A lower limit of the content ratio of the 2-cyanoacrylate that has an ether bond in an ester residue is not particularly limited, and is preferably 0% by mass or more.

<(Meth)Acrylate that has Two or More (Meth)Acryloyloxy Groups>

The composition of the present invention may contain a (meth)acrylate that has two or more (meth)acryloyloxy groups for the purpose of imparting heat resistance and flexibility. A variety of (meth)acrylates, each of which has two or more (meth)acryloyloxy groups, may be used, and those not having a functional group such as an amine which may adversely affect adhesiveness of 2-cyanoacrylate are preferable. An upper limit of the number of (meth)acryloyloxy groups is not particularly limited, and may be, for example, 6 or less.

Examples of (meth)acrylate that has two (meth)acryloyloxy groups include ethylene glycol di(meth)acrylate [examples of commercially available products include NK ESTER 1G (manufactured by Shin-Nakamura Chemical Co., Ltd.), and the same applies below.], polyethylene glycol di(meth)acrylate [acrylate: ARONIX M-240 (manufactured by Toagosei Co., Ltd.) or the like, methacrylate: NK ESTER 4G, 9G 14G 23G (manufactured by Shin-Nakamura Chemical Co., Ltd.), or the like.], tripropylene glycol di(meth)acrylate [ARONIX M-220 (manufactured by Toagosei Co., Ltd.) or the like], neopentyl glycol di(meth)acrylate [LIGHT ACRYLATE NP-A (manufactured by Kyoeisha Chemical Co., Ltd.) or the like], 1,6-hexanediol di(meth)acrylate [LIGHT ACRYLATE 1.6HX-A (manufactured by Kyoeisha Chemical Co., Ltd.) or the like], an ethylene oxide-modified di(meth)acrylate of bisphenol A [ARONIX M-211B (manufactured by Toagosei Co., Ltd.) or the like], 3-(meth)acryloyloxyglycerin mono (meth)acrylate [LIGHT ACRYLATE G-201P (manufactured by Kyoeisha Chemical Co., Ltd.) or the like], a hydrogenated dicyclopentadienyl di(meth)acrylate [LIGHT ACRYLATE DCP-A (manufactured by Kyoeisha Chemical Co., Ltd.) or the like], a polyester (meth)acrylate represented by Formula (1) below [KAYARAD HX-220, 620 (manufactured by Nippon Kayaku Co., Ltd.) or the like], an urethane (meth)acrylate [ARONIX M-1100, 1200 (manufactured by Toagosei Co., Ltd.) or the like], and a bisphenol A-diepoxy-(meth)acrylic acid adduct [BISCOAT #540 (manufactured by OSAKA ORGANIC CHEMICAL INDUSTRY LTD.) or the like].

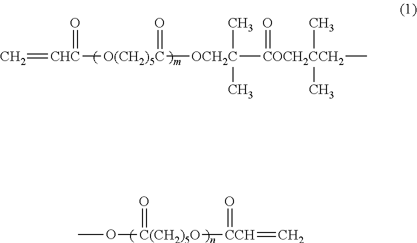

In Formula (1), an average value of (m+n) is from 2 to 4.

Examples of (meth)acrylate that has three (meth)acryloyloxy groups include pentaerythritol tri(meth)acrylate [ARONIX M-305 (manufactured by Toagosei Co., Ltd.) or the like], trimethylolpropane tri(meth)acrylate [ARONIX M-309 (manufactured by Toagosei Co., Ltd.) or the like], a trimethylolpropane propylene oxide-modified tri(meth)acrylate [ARONIX M-321 (manufactured by Toagosei Co., Ltd.) or the like], and trimethylolpropane tri(meth)acrylate [NK ESTER A-TMPT, TMPT (manufactured by Shin-Nakamura Chemical Co., Ltd.) or the like].

Examples of (meth)acrylate that has four (meth)acryloyloxy groups include pentaerythritol tetra(meth)acrylate [ARONIX M-450 (manufactured by Toagosei Co., Ltd.) or the like], examples of (meth)acrylate that has five (meth)acryloyloxy groups include dipentaerythritol penta(meth)acrylate, and examples of (meth)acrylate that has six (meth)acryloyloxy groups include dipentaerythritol hexa(meth)acrylate [KAYARAD DPHA (Nippon Kayaku Co., Ltd.)] and a dipentaerythritol propylene oxide-modified hexa(meth)acrylate [KAYARAD DPCA-20, 30, 60, 1209; manufactured by Nippon Kayaku Co., Ltd.]. These may be used in combination of two or more.

Among these, it is preferable to use an acrylate represented by Formula (1), polyethylene glycol di(meth)acrylate, polypropylene glycol di(meth)acrylate, or the like, since a cured product of an obtained composition has appropriate flexibility.

A content ratio of the (meth)acrylate that has two or more (meth)acryloyloxy groups is preferably 50% by mass or less, and more preferably from 10% by mass to 35% by mass, with respect to a total amount of the composition, from the viewpoint of water resistance and thermal shock resistance.

<Polymerization Initiator>

It is preferable to contain a polymerization initiator in the composition of the present invention. In particular, in the case of containing the (meth)acrylate component that has two or more (meth)acryloyloxy groups in the composition of the present invention, it is preferable to contain a radical initiator that can accelerate polymerization of the (meth)acrylate component that has two or more (meth)acryloyloxy groups. Examples of the radical initiator include a hydroperoxide, a peroxyester, a ketone peroxide, a peroxyketal, a dialkyl peroxide such as di-t-butyl hydroperoxide, and an organic peroxide such as diacyl peroxide or peroxydicarbonate.

From the viewpoint of storage stability, a content amount of the polymerization initiator is preferably from 0.1% by mass to 1% by mass, and more preferably from 0.3% by mass to 0.6% by mass, with respect to a total amount of the composition.

<Other Components>

In the composition of the present invention, stabilizers, polymerization accelerators, thickeners, and other additives shown below may be appropriately contained as optional components in amounts that are usually employed.

[Stabilizer] Stabilizers serve as polymerization inhibitors for improving storage stability of the composition of the present invention, and examples thereof include hydroquinone and sulfurous acid gas.
[Polymerization accelerator] Polymerization accelerators are for accelerating adhesion rate of the composition of the present invention, and examples of anionic polymerization accelerators include a polyalkylene oxide and a derivative thereof, a crown ether and a derivative thereof, a silacrown ether and a derivative thereof, a cyclodextrin, and a calixarene and a derivative thereof.
[Thickener] 2-Cyanoacrylate is intrinsically a colorless, transparent, and low-viscosity liquid, and a viscosity or thixotropy may be imparted to the composition of the present invention by, for example, dissolving or dispersing, as thickeners, homopolymers or copolymers of various (meth)acrylates, acrylic rubbers, cellulose derivatives, silica, or the like.
[Other Additives] In addition to the above, dyes, pigments, plasticizers, diluents, or the like may be also contained.

<Applications>

The composition for sealing a covered wire of the present invention can be used for a variety of covered wires such as a single wire that is covered with an insulating covering, or a strand wire obtained by twisting several wires that is covered with an insulating covering.

Specifically, an exposed portion and its periphery of a covered wire are covered with the composition of the present invention, and the composition is cured, whereby the periphery of the exposed portion of the covered wire can be sealed.

As the covering method, a variety of methods may be employed, and examples thereof include (i) a method of applying or injecting the composition of the present invention to an exposed portion and its periphery of a covered wire and (ii) a method of immersing, in the composition of the present invention, an exposed portion and its periphery of a covered wire.

As the method of curing a covered composition of the present invention, a method usually used for cyanoacrylate adhesives can be applied. Usually, the covered composition is allowed to stand, thereby being cured with moisture in the air. However, in the case in which a curing rate of the composition is not sufficient, an amine that is an anionic polymerization initiator such as N,N′-dimethylaniline, triethanolamine [examples of commercially available products include AA ACCELERATOR (Toagosei Co., Ltd.)], or the like may be sprayed to the covered portion to accelerate curing.

Among the compositions of the present invention, a low-viscosity composition is preferable since such a composition can easily percolate into a gap between a conductor and a covering, can sufficiently seal a covered wire, and is excellent in workability, and it is preferable to employ a method of immersing, in the composition of the present invention, an exposed portion and its periphery of a covered wire.

More specifically, a conductor from which covering of a covered wire has been peeled is swaged with specific parts, and the exposed portion and its periphery of the covered wire are immersed in the composition of the present invention. An immersing time for immersing the exposed portion and its periphery of the covered wire may be appropriately selected depending on the kind of a composition to be used, and is usually from about several seconds to about 30 seconds.

In this method, in the case in which the curing rate is too high and a composition does not sufficiently percolate into a gap between a conductor and covering, a composition in which a ratio of the polymerization inhibitor described above has been increased may be used.

### EXAMPLES

Hereinafter, the present invention will be more specifically described with reference to Examples and Comparative Examples.

### Examples 1 to 21

In Examples 1 to 6 and 8 to 9 respectively, each compound was used in a formulation as shown in Table 1, and a composition for sealing a covered wire was prepared by a conventional method. In Examples 7 and 10 to 21 respectively, each compound was used in a formulation as shown in Table 1, and, with respect to a total amount of 100 parts by mass of the respective compound, 1 part by mass of di-t-butyl hydroperoxide [PERBUTYL Z (manufactured by NOF Corporation)] was further contained, and a composition for sealing a covered wire was prepared by a conventional method.

### Comparative Examples 1 to 6

In Comparative Examples 1 to 3 and 6 respectively, each compound was used in a formulation as shown in Table 1, and a composition for sealing a covered wire was prepared by a conventional method. In Comparative Examples 4 to 5 respectively, each compound was used in a formulation as shown in Table 1, and, with respect to a total amount of 100 parts by mass of the respective compound, 1 part by mass of di-t-butyl hydroperoxide [PERBUTYL Z, manufactured by NOF Corporation] was further contained, and a composition for sealing a covered wire was prepared by a conventional method.

<Evaluation>

The following evaluation was made on the obtained composition for sealing a covered wire. The results are shown in Table 1.

Wire Sealability Test

A covering PVC of a soft PVC covered conductor (conductor diameter: 2.5 mm in terms of diameter of strand obtained by twisting 30 copper wires, outer diameter of covered PVC: 3.5 mm) was peeled 15 mm from the tip, and 30 mm from the tip was immersed in each composition for sealing a covered wire for about 2 seconds, and then matured for 1 day or more in an atmosphere of 23° C. and 50% humidity to be cured.

A wire sealability test was conducted on the sealed covered wire that had been exposed to a wet heat environment of 80° C. and 95% humidity for 50 hours (wet heat test).

A wire sealability test was also conducted, in the same manner as described above, on the sealed covered wire that had been subjected to 100 cycles of thermal shocks under a condition of from −40° C. for 30 minutes to 120° C. for 30 minutes (thermal shock test).

A wire sealability test was also conducted, in the same manner as described above, on the sealed covered wire that had been exposed to 120° C. for 96 hours (heat resistance test).

In the wire sealability test, compressed air having a predetermined pressure shown below was sent from a side of the covered wire that had not been sealed, and the tip of the covered wire was immersed in water to confirm air leakage.

In the table, AA, A, B, and C each represent the following meanings:

AA: Airtight pressure of 0.6 kg/cm² or more

A: Airtight pressure of 0.3 kg/cm² or more and less than 0.6 kg/cm²

B: Airtight pressure of 0.1 kg/cm² or more and less than 0.3 kg/cm²

C: Airtight pressure of less than 0.1 kg/cm²

As can be clearly understood from Table 1, all of Examples indicated an airtight pressure of 0.1 kg/cm² or more as a result of the wet heat test, the thermal shock test, and the heat resistance test, and sealability was favorable.

On the other hand, in each of Comparative Examples, in which an alkyl-2-cyanoacrylate that has, in a main chain, an alkyl group having 4 or more carbon atoms was not contained, the result of the wet heat test or the thermal shock test was not satisfactory, or the results of both these tests were not satisfactory.

In each of Comparative Examples 1 and 2, in which only an alkyl-2-cyanoacrylate that has, in a main chain, an alkyl group having 1 to 3 carbon atoms was contained as 2-cyanoacrylate, the result of the wet heat test was favorable, but sealability was insufficient in the thermal shock test.

In Comparative Example 3, in which only 2-cyanoacrylate having an ether bond in an ester residue was contained as 2-cyanoacrylate, the result of the thermal shock test was favorable, but sealability was insufficient in the wet heat test.

In each of Comparative Examples 4 and 5, the composition for sealing a covered wire consists of: an alkyl-2-cyanoacrylate; a 2-cyanoacrylate that has an ether bond in an ester residue; and a (meth)acrylate that has two or more (meth)acryloyloxy groups, as is the case with Patent Document 2 but does not contain an alkyl-2-cyanoacrylate that has, in a main chain, an alkyl group having 4 or more carbon atoms unlike the present invention. Therefore, sealablity was insufficient in the wet heat test or the thermal shock test, or in both of these tests.

In Comparative Example 6, in which a content of the alkyl-2-cyanoacrylate that has, in a main chain, an alkyl group having 4 or more carbon atoms was lower than the lower limit defined in the present invention, the results of the wet heat test and the heat resistance test were favorable, but sealability was insufficient in the thermal shock test.

TABLE 1

| | Composition (parts by mass) | | | | | | | | |
|---|---|---|---|---|---|---|---|---|---|
| | Cyanoacrylate | | | | | | | | |
| | 2-Octyl- | 1-Octyl- | 1-Butyl- | 2-Ethylhexyl- | 1-Hexyl- | Ethyl- | Isobutyl- | Isopropyl- | Ethoxyethyl- |
| | 2-cyano | 2-cyano | 2-cyano | 2-cyano | 2-cyano | 2-cyano | 2-cyano | 2-cyano | 2-cyano |
| | acrylate | acrylate | acrylate | acrylate | acrylate | acrylate | acrylate | acrylate | acrylate |
| Example 1 | 100 | | | | | | | | |
| Example 2 | | 100 | | | | | | | |
| Example 3 | | | 100 | | | | | | |
| Example 4 | | | | 100 | | | | | |
| Example 5 | | | | | 100 | | | | |
| Example 6 | 75 | | | | | | | | 25 |
| Example 7 | 50 | | | | | 50 | | | |
| Example 8 | 75 | | | | | | 25 | | |
| Example 9 | 12.5 | | | | | | 87.5 | | |
| Example 10 | 25 | | | | | | 75 | | |
| Example 11 | 75 | | | | | 25 | | | |
| Example 12 | 100 | | | | | | | | |
| Example 13 | 100 | | | | | | | | |
| Example 14 | 100 | | | | | | | | |
| Example 15 | 40 | | | | | | 60 | | |
| Example 16 | 40 | | | | | | | 60 | |
| Example 17 | | 25 | | | | | 75 | | |
| Example 18 | | | 40 | | | | 60 | | |
| Example 19 | 50 | | | | | | 25 | | 25 |
| Example 20 | 50 | | | | | | 50 | | |
| Example 21 | 75 | | | | | | 25 | | |
| Comparative | | | | | | 100 | | | |
| Example 1 | | | | | | | | | |
| Comparative | | | | | | | 100 | | |
| Example 2 | | | | | | | | | |
| Comparative | | | | | | | | | 100 |
| Example 3 | | | | | | | | | |
| Comparative | | | | | | 25 | | | 75 |
| Example 4 | | | | | | | | | |
| Comparative | | | | | | | 50 | | 50 |
| Example 5 | | | | | | | | | |
| Comparative | 5 | | | | | | 95 | | |
| Example 6 | | | | | | | | | |

| | Composition (parts by mass) | | | | | |
|---|---|---|---|---|---|---|
| | (Meth)acrylate | | | | | Heat |
| | KAYARAD | Polypropylene | | Wet | Thermal | resistance |
| | HX-620 | glycol diacrylate | M-305 | heat test | shock test | test |
| Example 1 | | | | AA | AA | B |
| Example 2 | | | | AA | AA | B |
| Example 3 | | | | AA | A | B |
| Example 4 | | | | AA | AA | B |
| Example 5 | | | | AA | AA | B |
| Example 6 | | | | B | AA | B |
| Example 7 | 50 | | | AA | B | A |
| Example 8 | | | | AA | AA | A |
| Example 9 | | | | AA | A | A |
| Example 10 | 50 | | | AA | A | AA |
| Example 11 | 25 | | | AA | A | AA |
| Example 12 | 25 | | | AA | AA | AA |
| Example 13 | | 25 | | AA | AA | AA |
| Example 14 | 50 | | | AA | AA | AA |
| Example 15 | 50 | | | AA | AA | AA |
| Example 16 | 50 | | | AA | AA | AA |
| Example 17 | 50 | | | AA | B | AA |
| Example 18 | 50 | | | AA | B | A |
| Example 19 | 25 | | 5 | B | A | A |
| Example 20 | 35 | | 5 | AA | AA | AA |
| Example 21 | 15 | | 5 | AA | AA | AA |
| Comparative | | | | A | C | AA |
| Example 1 | | | | | | |
| Comparative | | | | A | C | AA |
| Example 2 | | | | | | |
| Comparative | | | | C | A | B |
| Example 3 | | | | | | |
| Comparative | 25 | | | C | A | B |
| Example 4 | | | | | | |
| Comparative | 50 | | | C | C | B |
| Example 5 | | | | | | |
| Comparative | | | | A | C | A |
| Example 6 | | | | | | |

### INDUSTRIAL APPLICABILITY

The composition for sealing a covered wire of the present invention is excellent in workability, and a cured product thereof can maintain wire sealability even under severe conditions such as high temperature and high humidity and under conditions of thermal cycles, and therefore, the composition can be widely utilized as a wire sealant for wiring of a variety of electric systems in automobiles, home appliances, OA equipment, and the like.

1. A composition for sealing a covered wire, the composition containing 2-cyanoacrylate comprising 10% by mass or more of an alkyl-2-cyanoacrylate that has, in a main chain, an alkyl group having 4 or more carbon atoms.

2. The composition for sealing a covered wire according to claim 1, wherein the alkyl-2-cyanoacrylate that has, in a main chain, an alkyl group having 4 or more carbon atoms is at least one selected from the group consisting of 2-octyl-2-cyanoacrylate, 2-ethylhexyl-2-cyanoacrylate, n-octyl-2-cyanoacrylate, n-hexyl-2-cyanoacrylate, and n-butyl-2-cyanoacrylate.

3. The composition for sealing a covered wire according to claim 1, the composition further containing at least one of an alkyl-2-cyanoacrylate that has, in a main chain, an alkyl group having 1 to 3 carbon atoms or a 2-cyanoacrylate that has an ether bond in an ester residue.

4. The composition for sealing a covered wire according to claim 3, wherein a content ratio of the alkyl-2-cyanoacrylate that has, in a main chain, an alkyl group having 1 to 3 carbon atoms is 10% by mass or more but 90% by mass or less with respect to a total amount of 2-cyanoacrylate.

5. The composition for sealing a covered wire according to claim 3, wherein a content ratio of the 2-cyanoacrylate that has an ether bond in an ester residue is 0% by mass or more but 40% by mass or less with respect to a total amount of 2-cyanoacrylate.

6. The composition for sealing a covered wire according to claim 1, the composition further containing a (meth)acrylate that has two or more (meth)acryloyloxy groups.

7. The composition for sealing a covered wire according to claim 6, wherein a content ratio of the (meth)acrylate that has two or more (meth)acryloyloxy groups is 50% by mass or less with respect to a total amount of the composition.

8. The composition for sealing a covered wire according to claim 6, the composition further containing a polymerization initiator.

9. A covered wire comprising a cured product of the composition for sealing a covered wire according to claim 1.
